(19) United States
(12) Patent Application Publication
(10) Pub. No.: US 2014/0327656 A1
(43) Pub. Date: Nov. 6, 2014

(54) PROJECTOR

(71) Applicant: FUNAI ELECTRIC CO., LTD., Osaka (JP)

(72) Inventor: Kenichi TAKEDA, Osaka (JP)

(73) Assignee: FUNAI ELECTRIC CO., LTD., Osaka (JP)

(21) Appl. No.: 14/247,606

(22) Filed: Apr. 8, 2014

(30) Foreign Application Priority Data
May 1, 2013 (JP) 2013-096557

(51) Int. Cl. G06F 3/042

(52) U.S. Cl. CPC G06F 3/0421
USPC 345/175

(57) ABSTRACT

A projector includes a projection unit and a light sensor unit. The projection unit is configured to project an image. The projection unit includes a laser beam generator that is configured to output a projection-use laser beam for the image and a positioning-use laser beam, and a scanner that is configured to scan the projection-use laser beam and the positioning-use laser beam. The light sensor unit is disposed separately from the projection unit. The light sensor unit includes a first light receiver that is configured to receive the projection-use laser beam that has been reflected by a detection object, and an indicator that is configured to be aligned with the positioning-use laser beam.

### CROSS-REFERENCE TO RELATED APPLICATIONS

This application claims priority to Japanese Patent Application No. 2013-096557 filed on May 1, 2013. The entire disclosure of Japanese Patent Application No. 2013-096557 is hereby incorporated herein by reference.

### BACKGROUND

1. Field of the Invention

This invention generally relates to a projector. More specifically, the present invention relates to a projector with a projection unit.

2. Background Information

Projectors having a projection device are well-known in the art (see Japanese Unexamined Patent Application Publication No. 2012-108233 (Patent Literature 1), for example).

The above-mentioned Patent Literature 1 discloses a projector having a projection unit (e.g., a projection device), a projected light unit, and a visible camera. The projection unit uses a laser beam to project an image onto a projection surface. The projected light unit emits visible light that is substantially parallel to the projection surface, near the projection surface. The visible camera captures a projected image produced by the projection unit and reflected light reflected by the user's finger, etc. With this projector, the position touched by the user on the projected image produced by the projection unit is detected based on the reflected light captured by the visible camera. Also, with this projector, the projection unit, the projected light unit, and the visible camera are provided integrally.

### SUMMARY

With the projector discussed in the above-mentioned Patent Literature 1, in order to increase the size of the image projected onto the projection surface, it will be necessary for the projection unit to be disposed farther away from the projection surface. However, since the projected light unit has to be installed near the projection surface, the projector ends up being larger by an amount corresponding to the distance between the projected light unit and the projection device inside the projector.

In this case, it is possible to reduce the size of the projector by separating the projection device from the detection device used to detect the user's touch position.

However, it has been discovered that with a configuration in which the projection device and the detection device are separated, it is difficult to install the detection device in the proper state (e.g., the layout position and direction of the detection device) with respect to the projection device.

One aspect is to provide a projector in which a light sensor unit can be installed at a proper position and direction with respect to a projection unit even when the projection unit and the light sensor unit are installed separate from each other.

In view of the state of the known technology, a projector is provided that includes a projection unit and a light sensor unit. The projection unit is configured to project an image. The projection unit includes a laser beam generator that is configured to output a projection-use laser beam for the image and a positioning-use laser beam, and a scanner that is configured to scan the projection-use laser beam and the positioning-use laser beam. The light sensor unit is disposed separately from the projection unit. The light sensor unit includes a first light receiver that is configured to receive the projection-use laser beam that has been reflected by a detection object, and an indicator that is configured to be aligned with the positioning-use laser beam.

Also other objects, features, aspects and advantages of the present disclosure will become apparent to those skilled in the art from the following detailed description, which, taken in conjunction with the annexed drawings, discloses selected embodiments of the projector.

### BRIEF DESCRIPTION OF THE DRAWINGS

Referring now to the attached drawings which form a part of this original disclosure:

FIG. 1 is a diagram of the overall configuration of a projector in accordance with a first embodiment;

FIG. 2 is a block diagram of the projector in accordance with the first embodiment;

FIG. 3 is a diagram of a message image displayed when a light sensor has been correctly installed in the projector in accordance with the first embodiment;

FIG. 4 is a diagram of a message image displayed when the light sensor has not been correctly installed in the projector in accordance with the first embodiment;

FIG. 5 is a diagram illustrating the layout of an indicator in the light sensor of the projector in accordance with the first embodiment;

FIG. 6 is a diagram of the relation between the indicator of the light sensor and a graduation-use image (e.g., a line image) projected by the projector in accordance with the first embodiment;

FIG. 7 is a diagram illustrating the projection position of the graduation-use image (e.g., the line images) projected from a projection device of the projector in accordance with the first embodiment;

FIG. 8 is a diagram of the overall configuration of a projector in accordance with a second embodiment;

FIG. 9 is a block diagram of the projector in accordance with the second embodiment;

FIG. 10 is a side view of the overall configuration of the projector in accordance with the second embodiment;

FIG. 11 is a diagram of the overall configuration of a projector in accordance with a third embodiment; and

FIG. 12 is a diagram illustrating a modification example of the indicator of the projector in accordance with the first embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

### First Embodiment

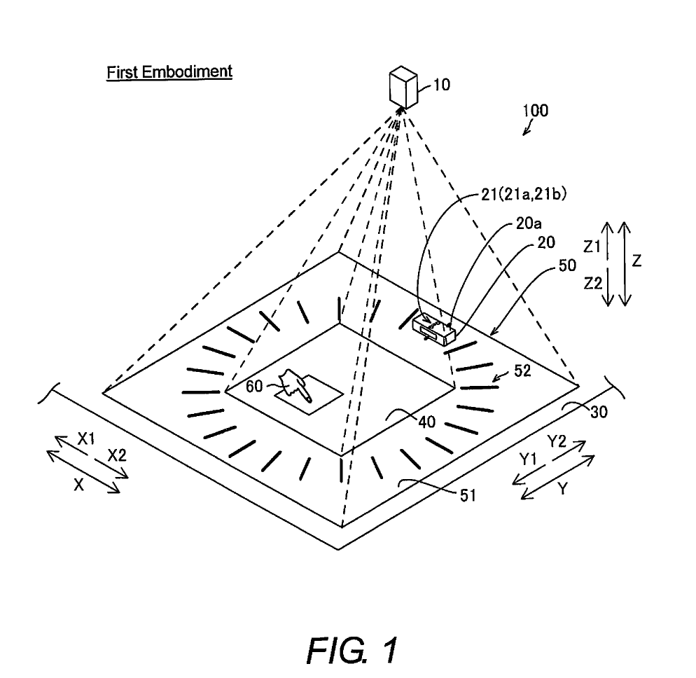

Referring to FIGS. 1 to 7, a projector 100 is illustrated in accordance with a first embodiment.

As shown in FIG. 1, the projector 100 pertaining to the first embodiment includes a projection device 10 (e.g., a projection unit) and a light sensor 20 (e.g., a light sensor unit) that is disposed separately from the projection device 10. The projector 100 is configured so that a display image 40 is projected by the projection device 10 downward (in the Z2 direction) from above a projection surface 30 (in the Z1 direction) onto a specific region of the projection surface 30. The projector 100 is also configured to acquire the position (e.g., coordinate position) of a detection object 60 (such as the user's finger) when the detection object 60 has been placed on the display image 40, via the light sensor 20 installed in a region on the outside of the display image 40. The display image 40 is an example of the “image” of the present invention.

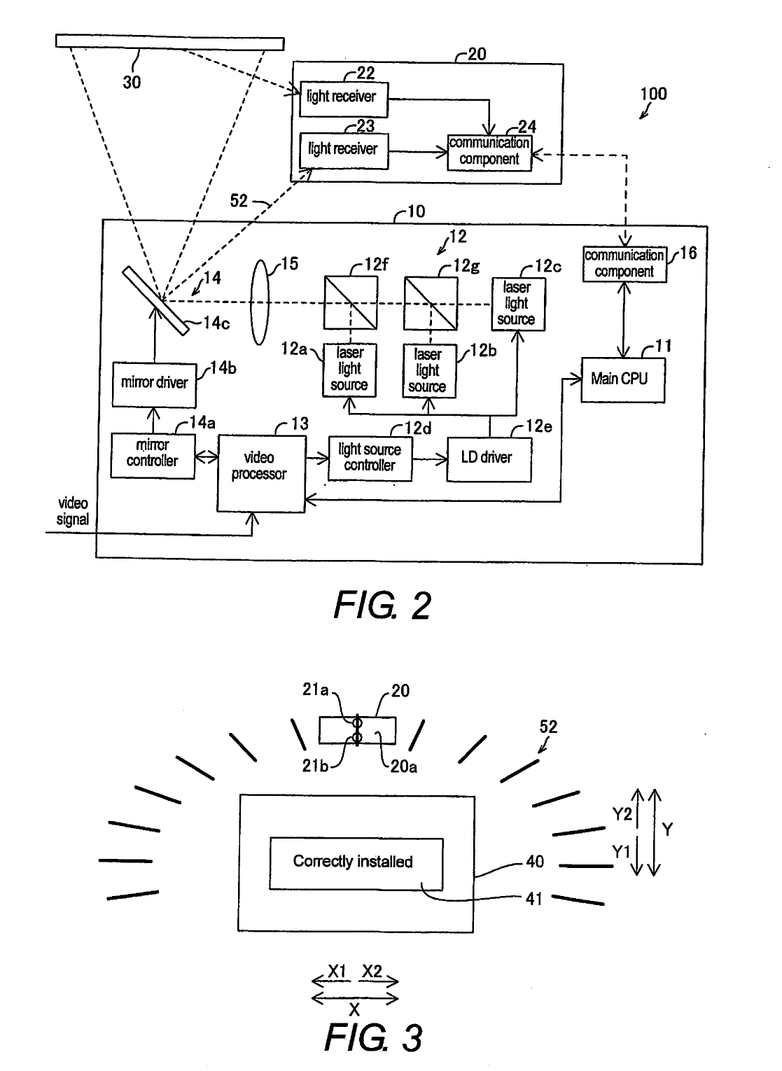

As shown in FIG. 2, the projection device 10 includes a main CPU (central processing unit) 11, a laser beam generator 12, a video processor 13, a scanner 14, an optical lens 15, and a communication component 16. The laser beam generator 12 includes a laser light source 12a, a laser light source 12b, a laser light source 12c, a light source controller 12d, an LD (laser diode) driver 12e, a beam splitter 12f, and a beam splitter 12g. The scanner 14 has a mirror controller 14a, a mirror driver 14b, and an MEMS (micro-electromechanical system) mirror 14c.

As shown in FIGS. 1 and 2, the light sensor 20 includes an indicator 21, a light receiver 22, a light receiver 23, and a communication component 24. The light sensor 20 is disposed on the projection surface 30, separately from the projection device 10. The light receiver 22 and the light receiver 23 are respectively examples of the “first light receiver” and “second light receiver” of the present invention.

The indicator 21 has an indicator 21a (e.g., an indicating portion) and an indicator 21b (e.g., an indicating portion) on the top 20a of the light sensor 20 (see FIG. 1). More specifically, as shown in FIG. 5, the indicators 21a and 21b are each formed as a substantially circular opening of approximately 5 mm or more and approximately 10 mm or less. Translucent cover members 21c and 21d are respectively fitted into the indicators 21a and 21b, and keep foreign matter from getting into the interior of the light sensor 20.

The light receiver 22 is configured so as to detect a laser beam reflected by the detection object 60 (see FIG. 1). More specifically, the light receiver 22 has a light reception range that spreads out like a fan in the forward direction (the Y1 direction) (the range to the boundary lines 22a and 22b shown in FIG. 7), and is configured to receive a laser beam reflected by the detection object 60 within the light reception range. As shown in FIG. 2, the light receiver 22 is configured to output, via the communication component 24, to the main CPU 11 of the projection device 10 the light reception result of receiving reflected light produced by the detection object 60.

The light receiver 23 is provided inside the light sensor 20 near the indicator 21 (see FIG. 1), and is configured to detect line images 52 (discussed below; see FIG. 1). The light receiver 23 is configured to output, via the communication component 24, to the main CPU 11 of the projection device 10 the light reception result of receiving the line images 52.

The main CPU 11 in the projection device 10 is configured to control the various components of the projector 100. More specifically, the main CPU 11 is configured to control the video processor 13. The main CPU 11 is also configured to acquire via the communication component 16 the detection result for the laser beams received by the light receiver 22 and the light receiver 23 of the light sensor 20. The main CPU 11 is also configured to acquire the position of the detection object 60 on the display image 40 based on the detection result for the laser beams received by the light receiver 22 of the light sensor 20. More precisely, the main CPU 11 is configured to determine which position on the display image 40 the detected laser beam has been scanned based on the timing the light receiver 22 detects the laser beam reflected by the detection object 60. The main CPU 11 is also configured to calculate the position of the detection object 60 corresponding to the display image 40.

As shown in FIG. 1, in the first embodiment, the projection device 10 is configured to project a graduation-use image 50 in the outer region of the projected display image 40. The graduation-use image 50 includes a background region 51 and the line images 52, which are in the form of graduations (or scales) disposed in a substantially circular ring (such as clock graduations) in the outer region of the display image 40. The light sensor 20 is configured so that the relative position of the light sensor 20 with respect to the projection device 10 can be set by installing the indicator 21 (21a and 21b) provided to the top 20a of the light sensor 20 so as to correspond to the projection position of one of the line images 52. The line images 52 are an example of the “positioning-use laser beam” of the present invention.

Also, in the first embodiment, the main CPU 11 (see FIG. 2) is configured so that information related to whether or not the relative position of the light receiver 23 of the light sensor 20 is correct is projected onto the projection surface 30 based on the detection result for the laser beam (e.g., the line images 52) received by the light receiver 23 of the light sensor 20. More specifically, the main CPU 11 is configured to project on the projection surface 30 the information related to whether or not the relative position of the light sensor 20 with respect to the projection device 10 is correct, based on the amount of light when the laser beam that forms the one of the line images 52 is detected by the light receiver 23.

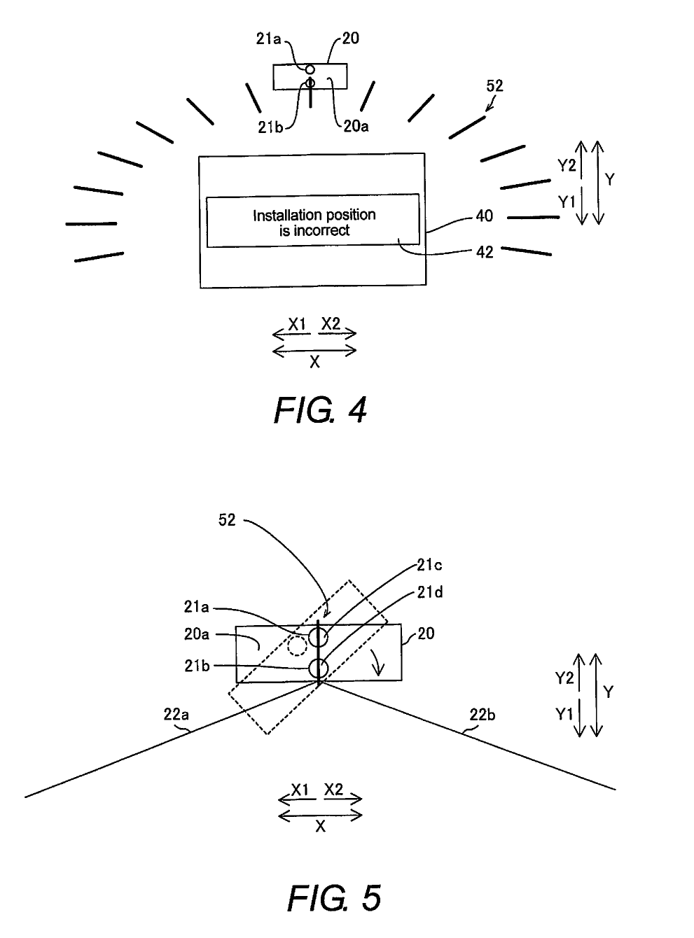

For example, as shown in FIG. 3, the main CPU 11 is configured so that if the installation position of the light sensor 20 is determined to be correct as a result of the laser beam being received by the light receiver 23, then the main CPU 11 projects in the display image 40 a message image 41 reading “Properly installed,” which tells the user that the light sensor 20 has been properly installed. As shown in FIG. 4, the main CPU 11 is also configured so that if the installation position of the light sensor 20 is determined to be incorrect as a result of the laser beam being received by the light receiver 23, then a message image 42 reading “Installation position is incorrect” is projected in the display image 40, which tells the user that the light sensor 20 has not been installed properly.

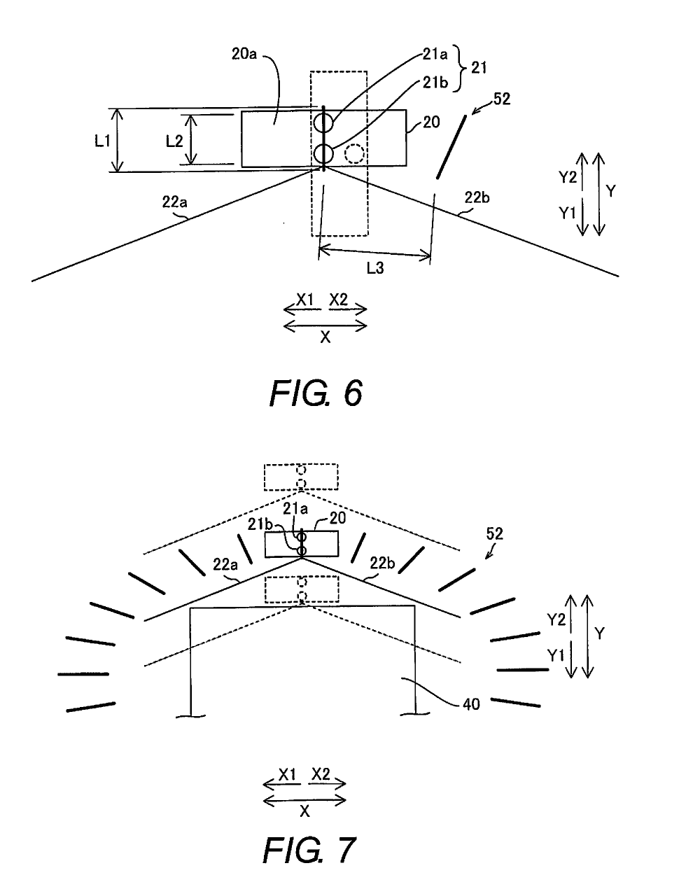

As shown in FIG. 5, in the first embodiment, the configuration is such that the indicator 21 of the light sensor 20 is provided at two places, as the indicator 21a and the indicator 21b, on the top 20a of the light sensor 20, and such that the installation direction of the light sensor 20 is set in one direction. More specifically, the configuration is such that the indicator 21a and the indicator 21b are aligned in the short-side direction of the light sensor 20, so as to correspond to the shape of the line image 52. For example, as shown in FIG. 5, the indicator 21 of the light sensor 20 is configured so that if the light sensor 20 is installed at the position indicated by a broken line, then the position of the light sensor 20 is adjusted to the direction indicated by the arrow in the drawing, and the indicator 21a and the indicator 21b are made to correspond to the line image 52, which fixes the installation direction of the light sensor 20 in one direction. As shown in FIG. 6, the line segment length L1 of the line image 52 is greater than the distance L2 between the indicator 21a and the indicator 21b provided to the top 20a of the light sensor 20. Also, the minimum spacing L3 of the adjacent line images 52 that are displayed in the form of graduations is greater than the distance L2 between the indicator 21a and the indicator 21b. As shown in FIG. 6, the configuration is such that even if the light sensor 20 is installed in the position indicated by the broken line, the indicator 21 of the light sensor 20 will not simultaneously enter the irradiation range of both of the projected beams of the adjacent line images 52. The distance L2 between the indicator 21a and the indicator 21b is an example of the length corresponding to the “specific range in which the indicator is provided” of the present invention.

Also, the main CPU 11 is configured so that of the graduation-use image 50, the background region 51 is projected as black, and the line images 52 as white. Consequently, the configuration is such that the contrast is increased between the line images 52 and the background region 51, which makes the line images 52 more visible. In FIG. 1, for the sake of convenience, the background region 51 is shown as being white and the line images 52 as black (thick black lines).

Also, the main CPU 11 is configured so that if the light sensor 20 has been properly installed in a specific position on the projection surface 30, projection of the line images 52 onto the background region 51 is stopped after a specific length of time has elapsed. Consequently, the light source used to form the background region 51 on which the line images 52 are projected can also be used to form the display image 40, which improves the quality of the display image 40.

As shown in FIG. 7, the line images 52 are projected so that the light sensor 20 can be installed in the correct relative position (e.g., the predetermined position) with respect to the projection device 10 (see FIG. 2). More specifically, the line images 52 are projected so that the light reception range of the light receiver 22 (see FIG. 2) when the light sensor 20 has been installed include the entire region in which the display image 40 is projected, and so that the light sensor 20 can be installed at a position that will not adversely affect the sensitivity (light reception sensitivity) of the light receiver 22. The light reception range of the light receiver 22 is the range over which the light receiver 22 can receive the laser beam reflected by the detection object 60 (see FIG. 1), and as shown in FIG. 7, is a range flanked by a boundary line 22a and a boundary line 22b in front of the light receiver 22 (in the Y1 direction).

Also, the laser beam generator 12 in the projection device 10 is configured to output a laser beam as shown in FIG. 2. More specifically, the laser light source 12a is configured so that blue laser light is reflected by the beam splitter 12f, goes through the optical lens 15, and irradiates the MEMS mirror 14c. The laser light source 12b is configured so that green laser light is reflected by the beam splitter 12g, goes through the beam splitter 12f and the optical lens 15, and irradiates the MEMS mirror 14c. The laser light source 12c is configured so that red laser light goes through the beam splitter 12g, the beam splitter 12f, and the optical lens 15, and irradiates the MEMS mirror 14c. The light source controller 12d is configured to control the LD driver 12e based on control provided by the video processor 13, and thereby control irradiation with the laser beams produced by the laser light sources 12a to 12C. More specifically, the light source controller 12d is configured to control the system so that laser beams of the line images 52 in the colors corresponding to the various pixels of the display image 40 are emitted from the laser light sources 12a to 12c to match the timing at which the MEMS mirror 14c is scanned.

The video processor 13 is configured to control the projection of video based on a video signal inputted from the outside. More specifically, the video processor 13 is configured to control the drive of the MEMS mirror 14c via the mirror controller 14a, and to control irradiation with the laser beams produced by the laser light sources 12a to 12c via the light source controller 12d.

The scanner 14 is configured to scan a laser beam and project the display image 40, the line images 52, the background region 51 onto the projection surface 30. More specifically, the mirror controller 14a of the scanner 14 is configured to control the mirror driver 14b and drive the MEMS mirror 14c. Also, the MEMS mirror 14c is configured to scan the laser beams emitted from the laser light sources 12a to 12c and project the display image 40, the line images 52, and the background region 51 onto the projection surface 30. The MEMS mirror 14c is also configured to scan the laser beams by driving in two axes, namely, the horizontal and vertical directions of the display image 40.

The communication component 16 is configured to send and receive signals to and from the projection device 10 and the light sensor 20 via the communication component 24 of the light sensor 20.

The communication component 24 in the light sensor 20 is configured to send the main CPU 11 the laser beam detection result of the light receiver 22 and the light receiver 23 via the communication component 16 of the projection device 10.

In the first embodiment, as discussed above, the light sensor 20 is provided so as to correspond to the irradiation position (e.g., the irradiation area) of the positioning-use line images 52 emitted from the projection device 10. Thus, even though the projection device 10 and the light sensor 20 are provided separately, the light sensor 20 can be installed in a state in which the indicator 21 is positioned at the line image 52 projected from the projection device 10. Specifically, the light sensor 20 can be disposed in the proper position and direction with respect to the projection device 10. Also, since the projection device 10 and the light sensor 20 can be installed separately, the projector 100 can be made more compact.

Also, in the first embodiment, as discussed above, the light sensor 20 is provided near the indicator 21, and includes the light receiver 23 that directly receives the positioning-use line images 52 emitted from the projection device 10. The projector 100 is configured so that whether or not the light sensor 20 has been installed in the correct relative position with respect to the projection device 10 is determined based on the detection result of the light receiver 23 for the positioning-use line images 52 from the projection device 10. Consequently, it can be easily ascertained whether or not the light sensor 20 has been installed in the proper position and direction with respect to the projection device 10 based on the detection result of the light receiver 23 for the positioning-use line images 52 from the projection device 10.

Also, in the first embodiment, as discussed above, the configuration is such that the information related to whether or not the light sensor 20 is in the correct installation position with respect to the projection device 10, based on the detection result of the light receiver 23 of the light sensor 20 for the positioning-use line images 52, is projected in the display image 40. Consequently, the user can refer to the information (e.g., the message images 41 and 42) related to whether or not the relative installation position of the light sensor 20 projected in the display image 40 with respect to the projection device 10. Thus, the user can reliably install the light sensor 20 in the correct position based on these projected and displayed message images 41 and 42.

Also, in the first embodiment, as discussed above, the configuration is such that the indicator 21 is provided at two places in the portion of the light sensor 20 where the positioning-use line images 52 can be directly emitted from the projection device 10. The indicators 21 a and 21 b provided at two places are installed so as to correspond to the irradiation positions of the positioning-use line images 52, which allows the light sensor 20 to be positioned relative to the projection device 10. Consequently, since the indicator 21 is provided at two places, the direction in which the light sensor 20 is disposed in the horizontal plane can be set. As a result, the light sensor 20 can be installed more reliably in the correct position.

Also, in the first embodiment, as discussed above, the projection device 10 is configured so that the outer region of the projected display image 40 is irradiated with the positioning-use line images 52. The light sensor 20 is installed in the outer region of the display image 40 so as to correspond to the irradiation position of the positioning-use line images 52 from the projection device 10, which allows the relative position of the light sensor 20 to be set with respect to the projection device 10. Consequently, since the outer region of the display image 40 is irradiated with the positioning-use line images 52, this avoids a situation in which the display image 40 is missing by an amount corresponding to the positioning-use line images 52, unlike when the positioning-use line images 52 irradiate inside the projection region. In addition, the light sensor 20 will not hinder the display image 40.

Also, in the first embodiment, as discussed above, the projection device 10 is configured to project the line images 52 in the outer region of the display image 40. The indicator 21 is installed so as to correspond to the projection position of one of the line images 52, thereby configuring such that the relative position of the light sensor 20 can be set with respect to the projection device 10. Consequently, the installation position of the light sensor 20 can be selected to correspond to any one of the graduation-like line images 52, so there is greater latitude in the installation of the light sensor 20.

Also, in the first embodiment, as discussed above, the configuration is such that the indicator 21 is provided over the specific range in a portion of the light sensor 20 in which the line images 52 from the projection device 10 can be directly projected. The line segment length L1 of the line images 52 is greater than the specific range L2 in which the indicator 21 is provided. Consequently, the light sensor 20 can be installed while sliding and adjusting the installation position of the light sensor 20 in the direction in which the line images 52 extend within the range of the line segment length L1 of the line images 52, by the amount by which the line segment length L1 of the line images 52 is greater than the specific range L2 in which the indicator 21 is provided. Thus, it is easier to adjust the installation of the light sensor 20, and there is greater latitude in the installation of the light sensor 20.

Also, in the first embodiment, as discussed above, the indicator 21 is provided over the specific range in a portion of the light sensor 20 in which the line images 52 from the projection device 10 can be projected directly. The minimum spacing L3 between adjacent line images 52 is greater than the specific range L2 in which the indicator 21 is provided. Consequently, even if the light sensor 20 is installed in the wrong direction, the indicator 21 will not enter the projection region of the line images 52 so that it straddles adjacent line images 52. Thus, this prevents the light sensor 20 from being installed improperly.

### Second Embodiment

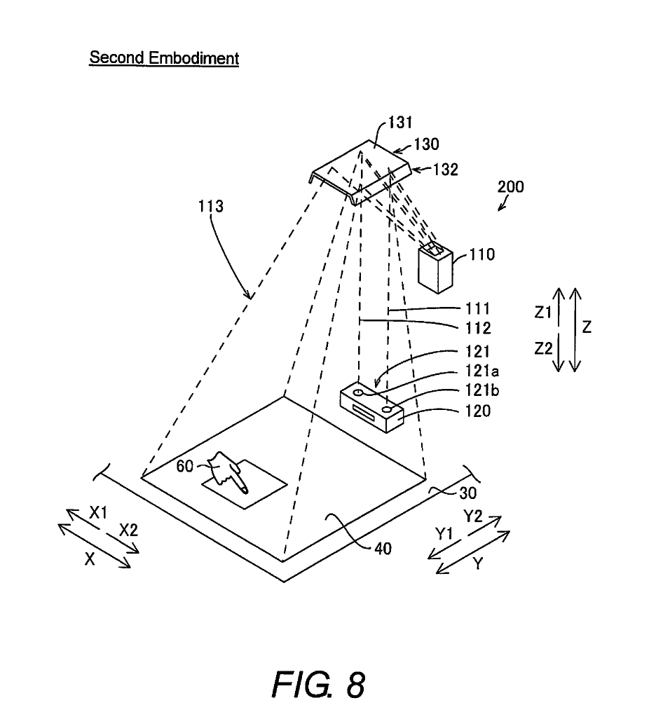

Referring now to FIGS. 8 to 10, a projector 200 in accordance with a second embodiment will now be explained. In view of the similarity between the first and second embodiments, the parts of the second embodiment that are functionally identical to the parts of the first embodiment will be given the same reference numerals as the parts of the first embodiment. Moreover, the descriptions of the parts of the second embodiment that are identical to the parts of the first embodiment may be omitted for the sake of brevity.

In the first embodiment, the graduation-like line images 52 are projected in the outer region of the display image 40. In the second embodiment, laser beams 111 and 112 that are substantially parallel to each other are formed by a mirror member 130 and projected in the outer region of the display image 40. The laser beams 111 and 112 are examples of the “plurality of positioning-use laser beams” of the present invention.

As shown in FIG. 8, the projector 200 in accordance with the second embodiment includes a projection device 110, a light sensor 120, and the mirror member 130. The light sensor 120 further includes an indicator 121.

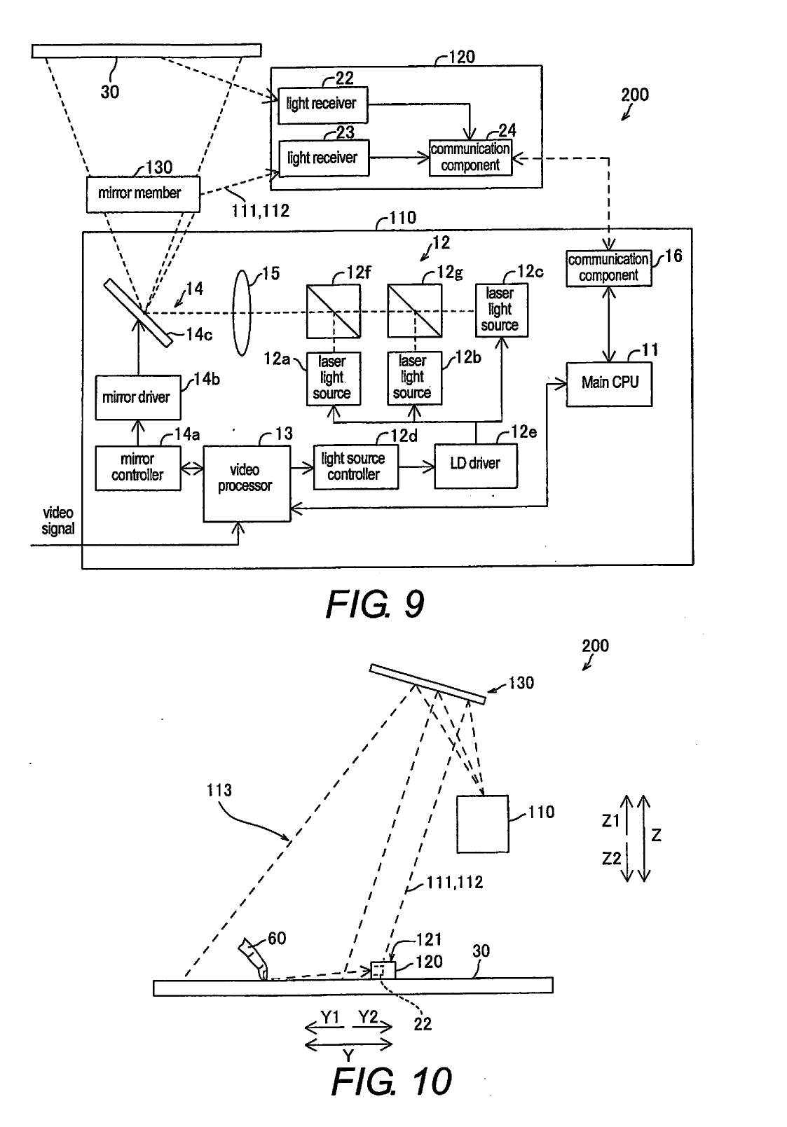

As shown in FIGS. 8 and 9, in the second embodiment, the main CPU 11 (see FIG. 9) is configured so that the laser beam of the projection device 110 is reflected by the mirror member 130, and the two specific laser beams 111 and 112 (e.g., linear light beams) that are substantially parallel to each other are scanned and projected in the display image 40 and in the outer region of the display image 40. More specifically, the main CPU 11 is configured to project the laser beams 111 and 112 that are substantially parallel to each other on the outside of the outermost edge of the display image 40 on the side near the projection device 110 (the Y1 direction). As shown in FIG. 10, the configuration is such that the laser beams 111 and 112 that are substantially parallel to each other are substantially parallel to the outermost edge of the projected light of the display image 40. Consequently, with the projector 200, the configuration is such that the relative position with respect to the projection device 110 can be set by installing the indicators 121a and 121b of the light sensor 120 so as to correspond to the irradiation positions of the laser beams 111 and 112 that are substantially parallel to each other.

Also, in the second embodiment, the mirror member 130 is configured integrally so that the two laser beams 111 and 112 and the display image 40 are all reflected toward the projection surface 30. More specifically, the mirror member 130 is configured to have a flat part 131 for reflecting a laser beam 113 used for the display image 40, and bent parts 132 for making the positioning-use laser beams 111 and 112 substantially parallel to each other. The laser beam 113 is an example of the “projection-use laser beam” of the present invention.

The rest of the configuration in the second embodiment is the same as in the first embodiment above.

In the second embodiment, as discussed above, the light sensor 120 is provided so as to correspond to the irradiation positions (e.g., the irradiation areas) of the positioning-use laser beams 111 and 112 emitted from the projection device 110. Thus, even though the projection device 110 and the light sensor 120 are provided separately, the light sensor 120 can still be disposed in the proper position and direction with respect to the projection device 110.

Also, in the second embodiment, as discussed above, the projection device 110 is configured to irradiate the outer region of the display image 40 with the positioning-use laser beams 111 and 112 that are substantially parallel to each other and are substantially parallel to the projected light of the display image 40. The indicator 121 is installed so as to correspond to the irradiation positions of the positioning-use laser beams 111 and 112 that are substantially parallel to each other and are substantially parallel to the laser beam 113 located at the outermost edge out of the scanned projection-use laser beam 113, which allows the light sensor 120 to be positioned relative to the projection device 110. Consequently, the height position of the light sensor 120 can be easily tracked by the projection device 110, and even if the position of the projection device 110 should move, the light sensor 120 can be easily installed in the correct position.

Also, in the second embodiment, as discussed above, there is provided the mirror member 130 that reflects the positioning-use laser beams 111 and 112 as well as the projection-use laser beam 113 projected by the projection device 110. The configuration is such that the mirror member 130 forms the positioning-use laser beams 111 and 112 that are substantially parallel to each other and are substantially parallel to the projected light of the display image 40. The indicator 121 is installed so as to correspond to the irradiation position of the positioning-use laser beams 111 and 112 that are substantially parallel to each other and are reflected by the mirror member 130. Thus, the light sensor 120 can be positioned relative to the projection device 110. Consequently, the mirror member 130 serves to reflect both the positioning-use laser beams 111 and 112 and the laser beam 113 used for the projected display image 40. Thus, there are fewer parts to the projector 200 than when a mirror member is provided separately from a mirror member that is used to reflect the laser beam 113 used for the projected display image 40, and the positioning-use laser beams 111 and 112 are formed substantially parallel. The rest of the effect of the second embodiment is the same as that in the first embodiment above.

### Third Embodiment

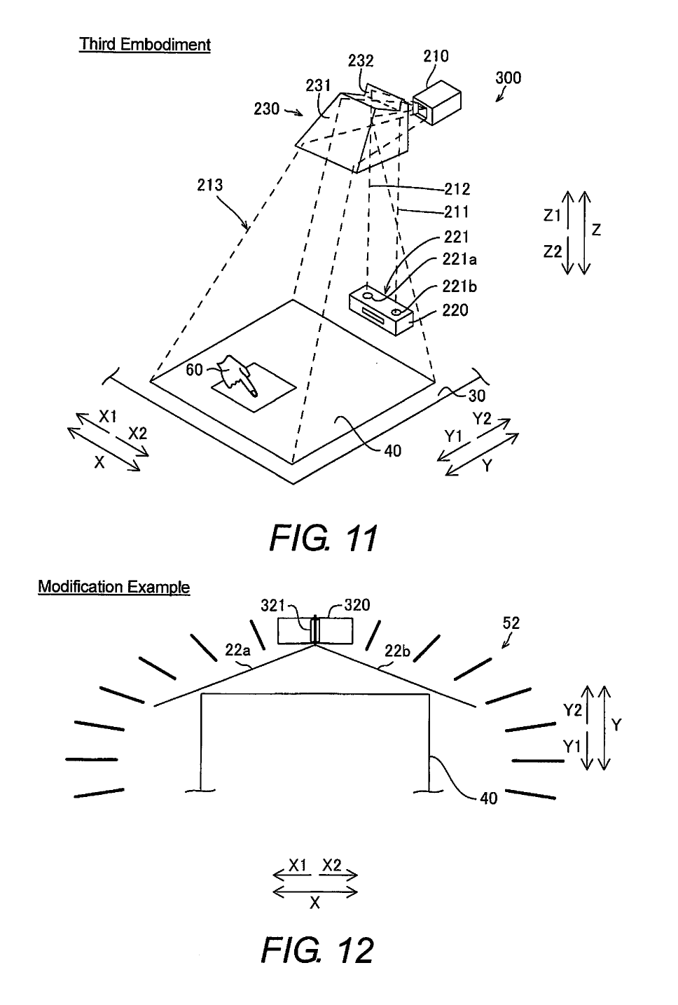

Referring now to FIG. 11, a projector 300 in accordance with a third embodiment will now be explained. In view of the similarity between the first to third embodiments, the parts of the third embodiment that are functionally identical to the parts of the first and second embodiments will be given the same reference numerals as the parts of the first and second embodiments. Moreover, the descriptions of the parts of the second embodiment that are identical to the parts of the first and second embodiments may be omitted for the sake of brevity.

In the second embodiment, the substantially parallel laser beams 111 and 112 are formed by the mirror member 130 and projected in the outer region of the display image 40. In the third embodiment, laser beams 211 and 212 that are substantially parallel to each other are formed by a prism member 230 and projected in the outer region of the display image 40. The laser beams 211 and 212 are examples of the “plurality of positioning-use laser beams” of the present invention.

As shown in FIG. 11, the projector 300 in accordance with the third embodiment includes a projection device 210, a light sensor 220, and the prism member 230. The light sensor 220 includes an indicator 221.

In the third embodiment, the configuration of the projector 300 is basically identical to the projector 200 shown in FIG. 9, except for the prism member 230. The main CPU 11 (see FIG. 9) is configured to reflect the laser beam with the prism member 230 and to project the display image 40 and the laser beams 211 and 212 that are substantially parallel to each other in the outer region of the display image 40. More specifically, the main CPU 11 is configured to project the laser beams 211 and 212 that are substantially parallel to each other on the outside of the outermost edge of the display image 40 on the side near the projection device 210 (the Y1 direction). Also, the configuration is such that the laser beams 211 and 212 that are substantially parallel to each other are substantially parallel to the outermost edge of the projected light of the display image 40. Consequently, with the projector 300, the configuration is such that the relative position with respect to the projection device 210 can be set by installing the indicators 221a and 221b of the light sensor 220 so as to correspond to the irradiation positions (e.g., the irradiation areas) of the laser beams 211 and 212 that are substantially parallel to each other.

Also, in the third embodiment, the prism member 230 is configured integrally so that the prism member 230 reflects the positioning-use laser beams 211 and 212 and the display image 40. More specifically, the prism member 230 has a reflecting face 231 that reflects the laser beam 213 used for the display image 40, and a reflecting face 232 for reflecting the positioning-use laser beams 211 and 212. The reflecting face 231 and the reflecting face 232 are formed so as to have mutually different angles. Also, the reflecting face 231 is formed on the far side (the display image 40 side) (Y2 direction) with respect to the reflecting face 232 as seen from the projection device 210.

The rest of the configuration of the third embodiment is the same as in the first embodiment above.

In the third embodiment, as discussed above, the light sensor 220 is provided so as to correspond to the irradiation positions of the positioning-use laser beams 211 and 212 emitted from the projection device 210. Thus, even though the projection device 210 and the light sensor 220 are provided separately, the light sensor 220 can still be disposed in the proper position and direction with respect to the projection device 210.

Also, in the third embodiment, as discussed above, the prism member 230 is provided which reflects both the projection-use laser beam 213 projected by the projection device 210, and the positioning-use laser beams 211 and the 212. The configuration is such that the prism member 230 forms the positioning-use laser beams 211 and 212 that are substantially parallel to each other and are substantially parallel to the projected light of the display image 40. The indicator 221 is provided so as to correspond to the irradiation positions of the positioning-use laser beams 211 and 212 that are substantially parallel to each other, via the prism member 230, which allows the light sensor 220 to be positioned relative to the projection device 210. Consequently, in changing the projection direction of the projection device 210, the projection direction of the projection device 210 can be changed by the single prism member 230, as opposed to when a plurality of mirror members are used to reflect the laser beams. Thus, fewer parts are required for the projector 300, and greater latitude is afforded in the layout of the projection device 210.

The rest of the configuration of the third embodiment is the same as in the second embodiment above.

The above descriptions of the embodiments are provided for illustration only, and should not be interpreted as being limiting the invention. The scope of the invention as defined by the appended claims and their equivalents rather than by the above descriptions of the embodiments.

For instance, in the first to third embodiments above, the user's finger is used as the detection object 60. However, the present invention is not limited to this. A touch pen, some other pen, or the like can be used instead as the detection object 60.

Also, in the first embodiment above, the indicator 21 of the light sensor 20 is provided at two places in the short-side direction (the Y axis direction), while in the second and third embodiments above, the indicator 121 (221) is provided at two places in the lengthwise direction (the X axis direction). However, the present invention is not limited to this. The indicator 21 (121, 221) can be provided at three or more places. Also, as shown in FIG. 12, the configuration can be such that a single indicator 321 formed in a substantially oblong shape is provided to a light sensor 320, instead of the indicator 21 in accordance with the first embodiment.

Also, in the first to third embodiments above, the light receiver 23 is provided near the indicator 21 (121, 221). However, the present invention is not limited to this. The light receiver 23 can not be provided, and the configuration can be such that the light receiver 23 is not provided, and just the indicator 21 (121, 221) is used to position the light sensor 20 (120, 220), with respect to the projection device 10 (110, 210). More specifically, the configuration can be such that positioning is accomplished by having the user visually recognize a situation in which the positioning-use laser beam 52 (111, 112, 211, 212) is irradiating the indicator 21 (121, 221).

Also, in the first embodiment above, the white line images 52 are projected onto the black background region 51 in the outer region of the display image 40. However, the present invention is not limited to this. Any color combination can be used for the line images 52 and the projection region of the line images 52 (the background region 51), as long as the line images 52 can be clearly made out from the projection region of the line images 52 (the background region 51). Also, the configuration can be such that just the line images 52 are projected in the outer region of the projected display image 40.

Also, in the first embodiment above, the line images 52 are projected in a substantially annular shape in the outer region of the projected display image 40. However, the present invention is not limited to this. As long as the line images 52 are projected in the outer region of the display image 40, the configuration can such that the formation range is less than 360 degrees, and the light is projected substantially in an arc shape, for example.

Also, in the second and third embodiments above, the positioning-use laser beams are emitted and the light sensor 120 (220) is installed on the same side as the projection device 110 (210). However, the present invention is not limited to this. The positioning-use laser beams 111 and 112 (211 and 212) can irradiate anywhere, as long as they irradiate the outer region of the projected display image 40. For instance, the positioning-use laser beams can irradiate the opposite side from the projector 110 (210), with the display image 40 in between.

Also, in the first to third embodiments above, the information (e.g., the message image 41 or 42) about whether or not the relative position of the light sensor 20 (120, 220) with respect to the projection device 10 (110, 210) is the correct position is projected on the display image 40. However, the present invention is not limited to this. Information about whether or not the relative position of the light sensor 20 (120, 220) with respect to the projection device 10 (110, 210) is the correct position can be indicated with a display lamp or the like. For instance, the configuration can be such that a display lamp is provided to the light sensor 20 (120, 220), and the lamp flashes when the installation is correct. Also, the information about whether or not the relative position of the light sensor 20 (120, 220) with respect to the projection device 10 (110, 210) is the correct position can be conveyed by sound. For instance, the configuration can be such that a specific notification sound is emitted, or the configuration can be such that a sound is emitted to prompt the reading of the message image 41 or 42.

Also, in the third embodiment above, the projection device 210 projects light in a direction parallel to the projection surface 30 and the projected light is reflected by the prism member 230. However, the present invention is not limited to this. The projection device 210 can instead project the light from another direction to the prism member 230. For instance, the prism member 230 can be provided between the projection device 210 and the projection surface 30, and the projection device 210 can project the light in a direction that is perpendicular to the projection surface 30.

The projector in accordance with one aspect of this invention includes a projection unit and a light sensor unit. The projection unit is configured to project an image. The projection unit includes a laser beam generator that is configured to output a projection-use laser beam for the image and a positioning-use laser beam, and a scanner that is configured to scan the projection-use laser beam and the positioning-use laser beam. The light sensor unit is disposed separately from the projection unit. The light sensor unit includes a first light receiver that is configured to receive the projection-use laser beam that has been reflected by a detection object, and an indicator that is configured to be aligned with the positioning-use laser beam.

With this projector, the light sensor unit is aligned with the irradiation area of the positioning-use laser beam emitted from the projection unit. Thus, even though the projection unit and the light sensor unit are disposed at separate locations, the light sensor unit can be installed in a state in which the indicator is aligned with the irradiation area (e.g., irradiation position or point) of the positioning-use laser beam from the projection unit. Specifically, the light sensor unit can be disposed in the proper position and direction with respect to the projection unit. Also, since the projection unit and the light sensor unit are installed separately, the projector can be more compact.

With the projector, the light sensor unit can further include a second light receiver that is arranged relative to the indicator. The second light receiver is configured to directly receive the positioning-use laser beam. The projection unit is further configured to determine whether or not the light sensor unit is installed in a predetermined position with respect to the projection unit based on a detection result of the positioning-use laser beam by the second light receiver. With this configuration, whether or not the light sensor unit has been disposed in the proper position and direction with respect to the projection unit can be easily ascertained based on the detection result produced by the second light receiver for the positioning-use laser beam from the projection unit.

In this case, the projection unit can be configured to project information indicative of whether or not the light sensor unit is installed in the predetermined position with respect to the projection unit in a projection region of the image based on the detection result of the positioning-use laser beam by the second light receiver. With this configuration, the user can refer to the information related to whether or not the relative installation position of the light sensor unit is correct with respect to the projection unit. Thus, the user can reliably install the light sensor unit in the correct position based on this projected display of the information.

With the projector, the indicator includes a plurality of indicating portions at locations on the light sensor unit. The indicating portions are aligned with an irradiation area of the positioning-use laser beam while the light sensor unit is installed in a predetermined position with respect to the projection unit. With this configuration, since the indicators are provided at two or more places, the direction in which the light sensor unit is disposed in the horizontal plane can be determined. With this configuration, the light sensor unit can be installed more reliably in the correct position.

With the projector, the projection unit is configured to irradiate an outer region of the image with the positioning-use laser beam. The light sensor unit is installed in the outer region of the image to correspond to an irradiation area of the positioning-use laser beam while the light sensor unit is installed in a predetermined position with respect to the projection unit. With this configuration, the positioning-use laser beam irradiates the outer region of the projected image. This avoids a situation in which the projected image is missing by an amount corresponding to the positioning-use laser beam, which is what happens when the projection region is irradiated with the positioning-use laser beam. In addition, the light sensor unit will not hinder the image projection.

In this case, the projection unit is configured to project a plurality of graduated line images in the outer region of the image as the positioning-use laser beam. The indicator is aligned with one of the graduated line images while the light sensor unit is installed in the predetermined position with respect to the projection unit. With this configuration, the installation position of the light sensor unit can be selected so as to correspond to any one of the graduated line images, which affords greater latitude in the installation of the light sensor unit.

With the projector, the indicator is arranged over a specific range on the light sensor unit. The graduated line images having a length that is greater than a length of the specific range. With this configuration, the light sensor unit can be installed while sliding and adjusting the installation position of the light sensor unit in the direction in which the graduated line images extend within the range of the line segment length of the graduated line images, by the amount by which the line segment length of the graduated line images is greater than the specific range in which the indicator is provided. Thus, it is easier to adjust the installation of the light sensor unit, and there is greater latitude in the installation of the light sensor unit.

With the projector, the indicator is arranged over a specific range on the light sensor unit. An adjacent pair of the graduated line images has a spacing therebetween that is greater than a length of the specific range. With this configuration, even if the light sensor unit is installed in the wrong direction, the indicator will not enter the projection region of the graduated line images so that it straddles the adjacent pair of the graduated line images. Thus, this prevents the light sensor unit from being installed improperly.

With the projector, the projection unit is configured to irradiate the outer region of the image with a plurality of positioning-use laser beams. The positioning-use laser beams being substantially parallel to each other and substantially parallel to the projection-use laser beam that scans an outermost edge of the image. The indicator is aligned with irradiation positions of the positioning-use laser beams while the light sensor unit is installed in the predetermined position with respect to the projection unit. With this configuration, even if the height position of the projection unit should move, the position of the light sensor unit can easily keep up with the projection unit. Thus, the light sensor unit can be easily installed in the correct position.

In this case, the projector can further includes a mirror member configured to reflect both the positioning-use laser beams and the projection-use laser beam from the projection unit. The mirror member is configured to deflect the positioning-use laser beams from the projection unit such that the positioning-use laser beams are substantially parallel to each other and substantially parallel to the projection-use laser beam that scans the outermost edge of the image. With this configuration, the indicator is installed so as to correspond to the irradiation positions of the positioning-use laser beams, which are substantially parallel to each other and reflected by the mirror member. This allows for the relative positioning of the light sensor unit with respect to the projection unit. With this configuration, the mirror member serves to reflect both the positioning-use laser beams and the projection-use laser beam used for the projected image. Thus, there are fewer parts to the projector than when a mirror member is provided separately from that used to reflect the projection-use laser beam used for the projected image, and the positioning-use laser beams are formed substantially parallel.

In this case, the projector can further includes a prism member configured to refract both the positioning-use laser beams and the projection-use laser beam from the projection unit. The prism member is configured to deflect the positioning-use laser beams from the projection unit such that the positioning-use laser beams are substantially parallel to each other and substantially parallel to the projection-use laser beam that scans the outermost edge of the image. With this configuration, the indicator is provided so as to correspond to the irradiation positions of the positioning-use laser beams, which are configured to be substantially parallel to each other via the prism member. This allows for the relative positioning of the light sensor unit with respect to the projection unit. With this configuration, when the irradiation direction of the projection unit is changed, this can be accomplished by a single prism, rather than using a plurality of mirror members to change the irradiation direction of the projection unit. Thus, fewer parts are required by the projector, and there is greater latitude in the layout of the projection unit.

With the present invention, as discussed above, a light sensor unit can be installed in the proper position and direction with respect to a projection unit in a projector having the projection unit and the light sensor unit.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts unless otherwise stated.

As used herein, the following directional terms “forward”, “rearward”, “front”, “rear”, “up”, “down”, “above”, “below”, “upward”, “downward”, “top”, “bottom”, “side”, “vertical”, “horizontal”, “perpendicular” and “transverse” as well as any other similar directional terms refer to those directions of a projector in an upright position. Accordingly, these directional terms, as utilized to describe the projector should be interpreted relative to a projector in an upright position on a horizontal surface.

Also it will be understood that although the terms “first” and “second” may be used herein to describe various components these components should not be limited by these terms. These terms are only used to distinguish one component from another. Thus, for example, a first component discussed above could be termed a second component and vice-a-versa without departing from the teachings of the present invention. The term “attached” or “attaching”, as used herein, encompasses configurations in which an element is directly secured to another element by affixing the element directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example, “joined”, “connected”, “coupled”, “mounted”, “bonded”, “fixed” and their derivatives. Finally, terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A projector comprising:
a projection unit configured to project an image, the projection unit including a laser beam generator that is configured to output a projection-use laser beam for the image and a positioning-use laser beam, and a scanner that is configured to scan the projection-use laser beam and the positioning-use laser beam; and
a light sensor unit disposed separately from the projection unit, the light sensor unit including a first light receiver that is configured to receive the projection-use laser beam that has been reflected by a detection object, and an indicator that is configured to be aligned with the positioning-use laser beam.

2. The projector according to claim 1, wherein
the light sensor unit further includes a second light receiver that is arranged relative to the indicator, the second light receiver being configured to directly receive the positioning-use laser beam, and
the projection unit is further configured to determine whether or not the light sensor unit is installed in a predetermined position with respect to the projection unit based on a detection result of the positioning-use laser beam by the second light receiver.

3. The projector according to claim 2, wherein
the projection unit is further configured to project information indicative of whether or not the light sensor unit is installed in the predetermined position with respect to the projection unit in a projection region of the image based on the detection result of the positioning-use laser beam by the second light receiver.

4. The projector according to claim 1, wherein
the indicator includes a plurality of indicating portions at locations on the light sensor unit, and
the indicating portions are aligned with an irradiation area of the positioning-use laser beam while the light sensor unit is installed in a predetermined position with respect to the projection unit.

5. The projector according to claim 1, wherein
the projection unit is configured to irradiate an outer region of the image with the positioning-use laser beam, and
the light sensor unit is installed in the outer region of the image to correspond to an irradiation area of the positioning-use laser beam while the light sensor unit is installed in a predetermined position with respect to the projection unit.

6. The projector according to claim 5, wherein
the projection unit is configured to project a plurality of graduated line images in the outer region of the image as the positioning-use laser beam, and
the indicator is aligned with one of the graduated line images while the light sensor unit is installed in the predetermined position with respect to the projection unit.

7. The projector according to claim 6, wherein
the indicator is arranged over a specific range on the light sensor unit, and
the graduated line images have a length that is greater than a length of the specific range.

8. The projector according to claim 6, wherein
the indicator is arranged over a specific range on the light sensor unit, and
an adjacent pair of the graduated line images has a spacing therebetween that is greater than a length of the specific range.

9. The projector according to claim 5, wherein
the projection unit is configured to irradiate the outer region of the image with a plurality of positioning-use laser beams, the positioning-use laser beams being substantially parallel to each other and substantially parallel to the projection-use laser beam that scans an outermost edge of the image, and
the indicator is aligned with irradiation areas of the positioning-use laser beams while the light sensor unit is installed in the predetermined position with respect to the projection unit.

10. The projector according to claim 9, further comprising
a mirror member configured to reflect both the positioning-use laser beams and the projection-use laser beam from the projection unit, the mirror member being configured to deflect the positioning-use laser beams from the projection unit such that the positioning-use laser beams are substantially parallel to each other and substantially parallel to the projection-use laser beam that scans the outermost edge of the image.

11. The projector according to claim 9, further comprising
a prism member configured to refract both the positioning-use laser beams and the projection-use laser beam from the projection unit, the prism member being configured to deflect the positioning-use laser beams from the projection unit such that the positioning-use laser beams are substantially parallel to each other and substantially parallel to the projection-use laser beam that scans the outermost edge of the image.
